(19) United States
(12) Patent Application Publication
(10) Pub. No.: US 2003/0036990 A1
(43) Pub. Date: Feb. 20, 2003

(54) Method and system for financing natural gas utility inventories in underground reservoirs

(76) Inventor: Paul R. Sprehe, Covington, LA (US)

Correspondence Address: Michael E. Martin, Gardere Wynne Sewell LLP, 1601 Elm Street, Suite 3000, Dallas,, TX, 75201, US

(21) Appl. No.: 09/805,959

(22) Filed: Mar. 14, 2001

(51) Int. Cl. G06F 17/60

(52) U.S. Cl. 705/37; 705/38

(57) ABSTRACT

A method and system for financing the purchase of natural gas for a gas utility company includes the provision of a financial intermediary entity which purchases gas for storage and enters into a sales contract with the utility. The intermediary entity may purchase gas from producers and pay transport and storage costs while the utility withdraws gas from storage inventory and distributes the gas to its customers as needed. The intermediary entity is created with a capital structure which has a financial credit rating superior to the utility and the intermediary entity profits from the financial interest rate spread between debt instruments issued by the intermediary and the price paid to the intermediary entity for gas withdrawn from storage by the utility. The intermediary entity utilizes risk assessment information to determine the terms and conditions of a contract with the utility and to ensure continuous access to natural gas storage inventory financing on preferred and favorable terms.

### FIELD OF THE INVENTION

The present invention pertains to a method and system for financing inventory of natural gas for use and distribution by a gas utility and wherein the financing of inventory is carried out by a separate entity acting as a financial intermediary which relies on operational and financial risk management information and the issuance of debt instruments into the financial markets as a source of capital.

### BACKGROUND

Traditionally, in the sale and distribution of natural gas, which is a widely used fuel, the gas is purchased in large quantities by a gas utility company in advance of the peak usage periods. The purchased gas is placed in storage as inventory, which is drawn down as customers of the utility demand. In order to assure that sufficient supplies are available from a gas utility storage or inventory facility, substantial amounts of capital must be spent by the gas utility in the purchase of gas and in advance of any recovery of monies through the sale of the gas to retail and wholesale customers

Many gas distribution or utility companies are part of a larger entity, such as an electricity producer and distribution company or so-called electric utility. The capital requirements for natural gas fuels for purchase, storage and distribution often exceed the financial ability of the utility to carry out without loss of financial liquidity and therefore profitability. Moreover, if the gas distribution business is only a small portion of the overall business of the utility company, the diversion of capital from the other surface gas distribution facilities and/or electricity generation and distribution part of the business may result in the inability to produce and distribute gas and/or electricity to the extent that these other facilities will also suffer from adverse credit availability and cash flow conditions.

Accordingly, in order to (a) insure adequate financial liquidity of natural gas utility companies, whether they be stand alone companies or form part of a larger integrated or combined electric utility company, (b) increase the efficiency of capital expenditures of such a company or companies, and (c) also insure the deliverability of sufficient quantities of natural gas during peak demand conditions, other means of financing utility working inventories of gas have been deemed desirable. It is to these ends that the present invention has been developed.

### SUMMARY OF THE INVENTION

The present invention provides a method and system for financing the purchase and storage of large volumes of natural gas, such as required by natural gas utility or distribution companies, for example

In accordance with one aspect of the invention, a system is provided which includes the establishment of an entity acting as a financial intermediary which pays for and takes title to the gas inventory of a gas utility company, subject to at least (a) one of a financing agreement, and (b) a sales contract between the financial intermediary and the utility company.

In accordance with another aspect of the invention a method is provided for financing the purchase and storage of natural gas which includes the steps of negotiating the gas purchase, transport and storage by the gas utility company. Price and quantity of the gas to be sold to the gas utility are established and a financial entity or intermediary pays for and takes title to the gas acquired by and stored by or for the gas utility company subject to at least one of (a) a financing agreement, and/or (b) a firm sales contract.

In accordance with another aspect of the method and system of the present invention the financing entity or intermediary funds the purchase of the gas inventory for the utility, takes title to the gas and periodically issues debt instruments including, for example, commercial paper. The commercial paper issuances are carefully balanced with regard to maturities through operational, financial, economic and risk management techniques. In this regard, the financing entity utilizes a risk management advisory service which may operate as part of the financing intermediary itself or as a specific entity. The risk management advisory service collects and analyzes information with regard to the historic demand/consumption patterns for territories served by a particular gas utility whose inventory is being financed.

Further in accordance with the invention, the territories may be analyzed with regard to population, housing units, retail space, industrial space and other economic factors. Still further, data such as heating/cooling degree days and weather forecasting using historical models are also analyzed. In this way, forecasting of the timing of cash flows to the utility and on to the financial intermediary may be provided by particular zip codes, for example, and modified by factors including demand/consumption patterns. Payment lag and payment schedules of gas consumers are also analyzed to determine the rollover needs for existing debt instruments, as well as their maturities and amounts.

In accordance with still a further aspect of the present invention a method of financing gas utility inventory is provided wherein the utility may then draw gas from storage or inventory in a normal manner and repayment to the financial entity is scheduled in accordance with gas withdrawals from storage. Rollover of monies owed to the financial intermediary entity is possible when inventory is not drawn by the end of a so-called heating season. The gas utility retains the right to resell inventory but all prices and quantities under the sales contract with the financial intermediary entity are on a take or pay basis.

The present invention also provides a system for financing natural gas inventories for gas utility companies wherein a new financial intermediary entity is created which has a particularly high credit rating as assigned by widely accepted credit rating agencies, which credit rating is in most instances, superior to the credit rating of the utility whose gas inventories are being financed. Thus the financial intermediary entity may take advantage of the spread between interest rates which would be charged to the gas utility and interest rates which the financial intermediary would be required to pay in the financial markets. Accordingly, the gas utility being financed is able to utilize its capital resources more efficiently while a new financial entity is created which is profitable through its capitalization structure and by charging interest rates which the utility company would pay in all events and which are greater than the new financial entity or intermediary is required to pay.

The method and system of the invention will be further understood and appreciated by those skilled in the art upon reading the detailed description which follows.

### BRIEF DESCRIPTION OF THE DRAWINGS

FIG. 1 is a diagram illustrating various transaction paths for natural gas purchases, commonly experienced for the production, distribution and sale of natural gas in North America;

FIG. 2 is a block diagram illustrating the relationship between the financial intermediary of the present invention, gas producers, utility companies and financial markets;

FIG. 3 is a diagram illustrating the relationship between the financial intermediary, utilities and risk management information flow; and

FIG. 4 is a diagram of the business flow process in accordance with a method of the present invention;

FIG. 5 is a diagram of the risk management analysis and flow process; and

FIG. 6 is a diagram illustrating the application of a risk algorithm in accordance with the invention for calculating the risk exposure presented to the financial intermediary.

### DETAILED DESCRIPTION OF PREFERRED EMBODIMENTS

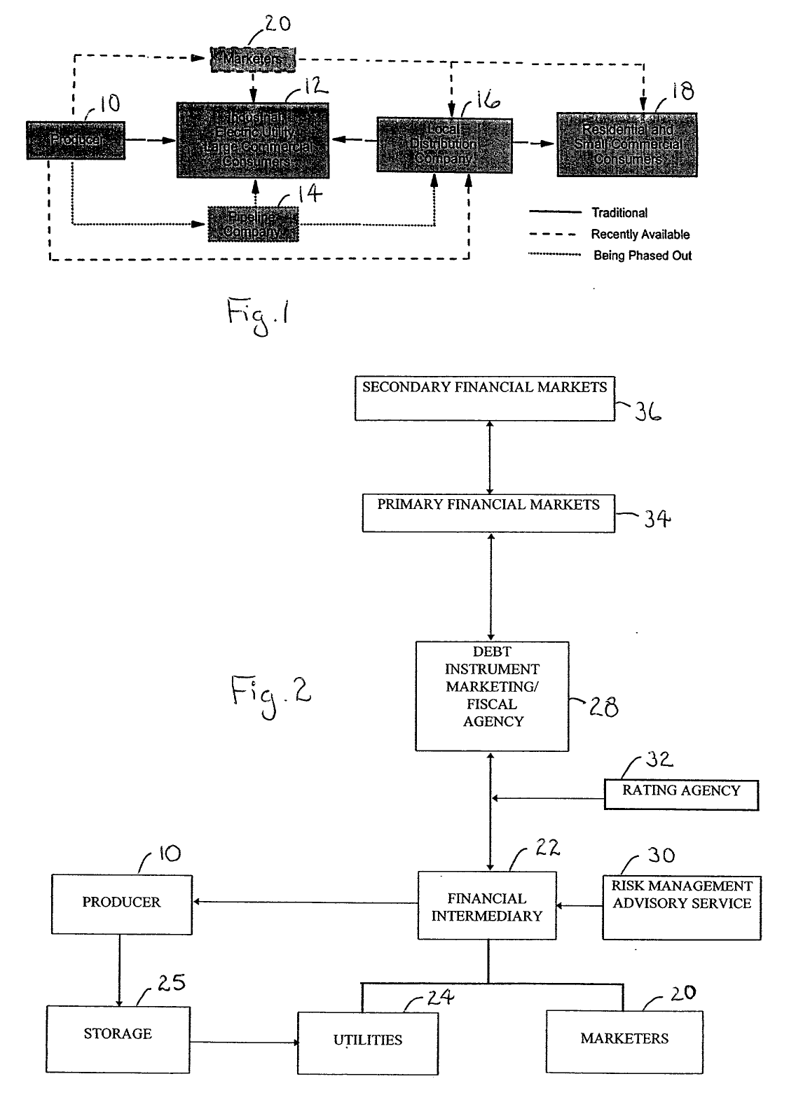

The production and distribution of a commodity known as natural gas is widespread throughout North America. Traditional transaction paths for natural gas purchases are indicated in FIG. 1 wherein a gas producer 10 sells directly to a large industrial or commercial consumer or to an electric utility, as indicated at 12. Traditionally, producers have also sold gas to pipeline companies 14 who may, in turn, sell the gas to large industrial, commercial or utility customers, as well as to a gas utility otherwise known as a local distribution company 16. The local distribution company 16 may, in turn, also sell gas to the large industrial, commercial, and electric utility consumer as well as to residential and small commercial consumers 18.

However, as indicated in the diagram of FIG. 1, a more recently available transaction path is directly from the producer 10 to the local distribution company (gas utility) 16 or to natural gas marketers 20 who, in turn, sell the gas to the local distribution company, or directly to residential and small commercial consumers 18. In instances where local distribution companies continue to purchase gas either directly from a producer 10 or a marketer 20, such distribution companies also continue to sell gas to all categories of consumer.

Gas utility companies are, in many instances, longstanding entities. In fact, some gas utility companies have evolved into gas and electric utility companies wherein the gas service was provided before electricity production and distribution was possible. In all events, gas utility companies, whether they are stand alone or part of a consolidated electric and gas utility entity are faced with significant capital requirements for the purchase, transport and storage of large quantities of natural gas, particularly in advance of the so-called heating season in many parts of the North American continent, for example.

Various factors, including environmental regulations, and deregulation of electric and gas utility companies have resulted in a downgrading of the financial credit quality of such companies which has resulted in an increase in their cost of capital to finance business transactions, such as the purchase and storage of large quantities of natural gas in advance of periods of peak demand including, as previously mentioned, the so-called heating season in many parts of North America. Accordingly, there has been a perceived need for the creation of an entity having superior credit quality which can provide the capital to finance the purchase of substantial quantities of natural gas required by gas utilities. The creation of such an entity or system and a method of operation of such an entity or system provides for increased financial liquidity in the utility industry as well as increased efficiency of deployment of capital within an individual utility company. Still further, the ability of utility companies to finance the purchase of natural gas in anticipation of peak demand periods, also insures deliverability of the gas product to the consumer during such periods of demand, as well as at other times throughout the consumption cycle.

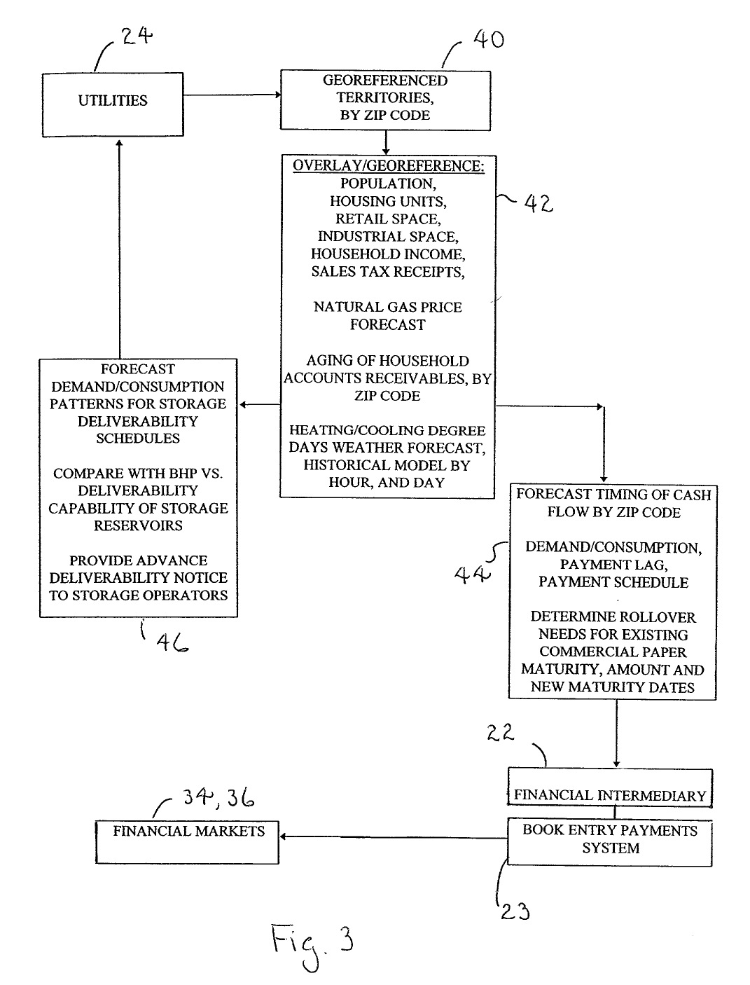

FIG. 2 illustrates the positioning of a new entity or so-called financial intermediary 22 which is operable to enter into transactions with a natural gas utility, or utilities, 24 as well as gas marketers 20, since these entities exist in the transaction path of natural gas from the producer to the end consumer, as indicated in FIG. 1. Moreover, the financial intermediary 22 also interacts with producers 10 who produce and place natural gas in a storage facility 25 for use by the utility or utilities 24. Gas storage facility 25 may be owned and controlled by producer 10, or a utility 24 or an independent storage operator. The financial intermediary 22 may also be referred to herein, and in the drawings, as “Utilicredit” 22. Utility 24 may also be referred to herein and in the drawings as a Local Distribution Company or “LDC”.

As further shown in FIG. 2, the financial intermediary 22 also interacts with debt instrument marketing agencies 28 and may include or enter into a contractual relationship with a risk management advisory service 30. In accordance with the invention, the financial intermediary 22 seeks a credit rating from one or more credit rating agencies 32 so that, through the debt instrument marketing agency (or agencies) 28, investment grade debt instruments may be placed into market 34, as indicated by the diagram of FIG. 2, and the primary marketers, in turn, may make a secondary market 36 to further enhance the liquidity of the commercial paper/debt instruments.

In order to assure the viability of the financial intermediary 22, this entity should assess the risks of ownership of the quantities of gas purchased and subject to a sales contract with a particular utility (or utilities) 24. In this regard the financial intermediary 22 requires a risk management advisory service, such as the advisory service 30, which may be an integral part of the financial intermediary or may be a separate entity providing the advisory service to the financial intermediary 22.

As shown in FIG. 3, certain information will be required from the utility (or utilities) 24 in order for the financial intermediary 22 to assess the risk of entering into contractual relationships with any one utility. The risk management advisory service 30 will obtain information regarding the geographical territories serviced by the utilities 24, which territories will be identified by zip code, as indicated in the box 40 of FIG. 3. Information indicated in box 42 of FIG. 3 may be obtained from the utilities 24, or independently. Such information includes population of the territories in question, by postal zip code, number of housing units, the amount of retail merchant space, occupied and unoccupied, the amount of industrial space, active and inactive, median and/or mean household income, and sales tax receipts for the territories in question on a historical basis.

Still further, the aging of household accounts receivables should be included in the information and given a particular weighting, again by zip code. Still further, the geographic area being serviced by the utility in connection with which the financial intermediary 22 will or has entered into a sales contract, requires analysis as to the heating/cooling degree days, weather forecast for the period of the sales contract and historical weather data by hour and day. This information together with a forecast of natural gas prices for the period of the sales contract in question can be used to forecast the timing of cash flow to the utility by consumers, by zip code, as indicated in the information to be developed in box 44 of FIG. 3. Historical gas demand/consumption data and customer payment lag and payment schedule data is also obtained and given a weighting. Additional information which must be factored into risk management based decisions is indicated in box 44 to include the rollover rate for existing debt instruments, namely commercial paper, including maturity dates, face value and a likely interest rate forecast for anticipated new maturity dates.

As further shown in FIG. 3 in box 46, the information obtained in box 42, including historical weather data and weather forecast data, is factored into a forecast for gas demand and consumption patterns to compare with gas storage capacity and deliverability rates which may be accomplished for the utility or utilities which have entered into sales contracts with the financial intermediary 22. This is necessary in order provide advance deliverability notices to the gas storage reservoir operators.

When all of the parameters indicated in box 42, box 44 and box 46 of FIG. 3 have been evaluated by the financial intermediary 22 using a suitable weighting factor for each parameter, the risk factors associated with assurance that the utilities will honor their sales contracts are compared with the needs of the financial intermediary 22 to repay lenders through the financial markets 34, 36. In order to minimize costs associated with borrowing by the financial intermediary 22, repayments by a book entry payment system 23, FIG. 3, should be implemented by the financial intermediary for payments to lenders.

As previously mentioned the financial intermediary 22 may be financially successful for, among other reasons, the capability of securing a superior credit rating as compared to the utilities that it services. For example, by assuming that the financial intermediary 22 is able to receive at least a AA financial credit rating (based on credit ratings ranging from AAA to BBB as investment grade with AAA being the highest rating and BBB being the lowest), the interest rate spread between a AA rated entity and an entity rated A normally averages about thirty basis points. Moreover, to this interest rate spread has been added the cost of a backup line of credit which, for a single A rated issue may be approximately be twelve to twenty-five basis points. Therefore, the actual interest rate spread between a AA rated entity and an A rated entity will be forty-two to fifty-five basis points. Still further, the cost of bank credit for an A rated utility is typically considered to be the London InterBank Offering Rate (LIBOR) plus seventy-five basis points. The LIBOR interest rate typically is about twenty basis points greater than the cost of financing a AA rated utility entity. Therefore the cost of funding storage inventory for a commodity such as natural gas for an A rated utility may be run about one hundred basis points over such costs for a AA rated utility entity.

Still further, the financial intermediary 22 may, if desired, be basically over capitalized. In this way, the financial intermediary 22 may receive at least a AA credit rating or possibly a AAA credit rating. Moreover, after several years of operation the new intermediary 22 may be able to lower its equity capital without losing a credit rating.

In recent markets, the cost of issuance of commercial paper type debt instruments is about twelve and one-half basis points. Accordingly, the financial intermediary 22, with a continuous entry into the financial markets and with an active available secondary market, should be able to obtain a concession to about ten basis points on the interest rate applied to funds borrowed, if it has a AA or AAA credit rating.

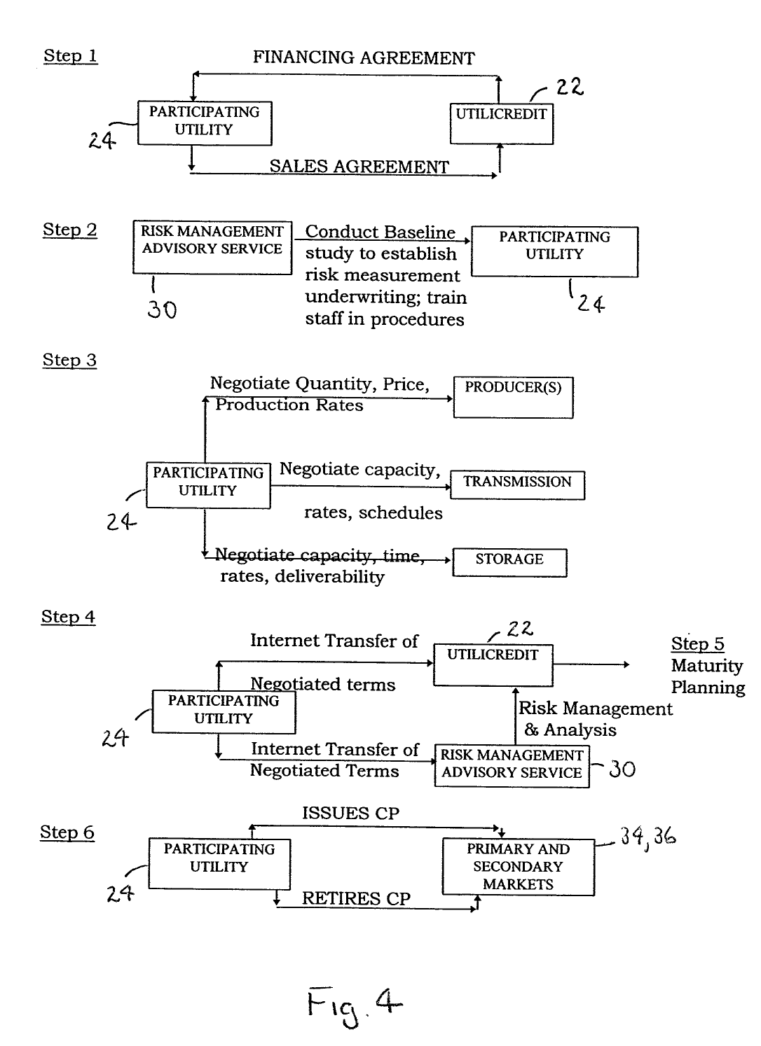

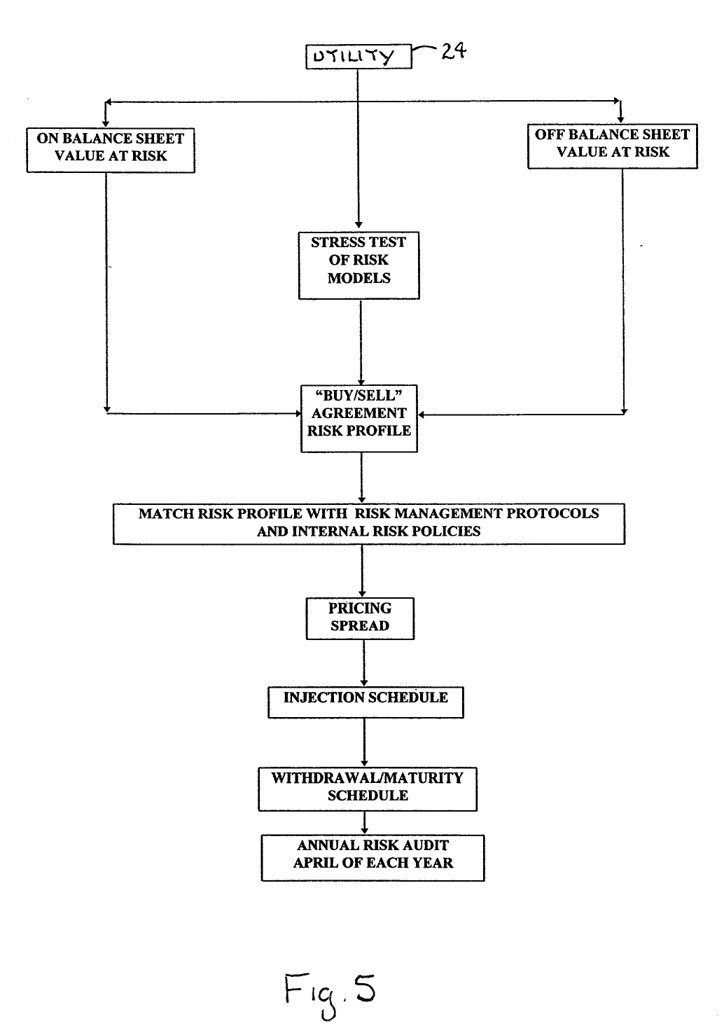

Certain steps in the business flow process are shown in FIG. 4. The operational sequence of steps for the financial intermediary 22, typically, would include the steps of negotiation for the cost of gas to be purchased, transported and stored in the normal course of business, by the utility with the gas producer and storage operator. Upon review of the negotiated fees to be paid by the utility for the purchase, transport and storage of natural gas, the financial intermediary 22 will, subject to a financing agreement and sales contract with the utility or utilities 24, pay for and take title to the gas inventory negotiated by the utility. Alternatively, the financial intermediary 22 may negotiate the gas purchase, transport and storage fees itself. In either case, the financial intermediary 22 then purchases the gas inventory and maintains ownership thereof with periodic issuances of debt instruments, primarily commercial paper, to cover the cost of same. As the commercial paper maturities occur they are carefully balanced with the aforementioned operational, financial and economic risk management information. In the course of a heating season or other period during which gas inventories are withdrawn by the utility and sold to its customers, payment for same to the financial intermediary 22 is carried out under the sales contract between the financial intermediary 22 and the utility (or utilities) 24.

Since repayment of debt instruments is scheduled within set time periods from withdrawals of natural gas from storage, rollover of debt instruments issued by the financial intermediary 22 may be required when inventory is not drawn by the end of a heating season. The agreement between the financial intermediary 22 and the utilities 24 may include the right for the utility to resell the inventory. However, the sales contract between the new entity financial intermediary 22 and the utility or utilities 24 will include take or pay provisions.

For forecasting both the peak volumes of commercial paper (CP) outstanding, and the average daily balance of CP outstanding (for earnings projection and capital estimate purposes) the past five year storage injection/withdrawal history from the American Gas Association (AGA) may be used. For example, peak volumes range between $6.7 billion with a gas price of $3.50/Mcf, and $9.8 billion with a gas price of $5.07/Mcf, based on the cycled volumes only. To forecast earnings and capital needs the average daily balance of commercial paper (CP) outstanding is used, and ranges between $3.4 billion at $3.50/Mcf, and $4.9 billion at $5.07/Mcf, based on the cycled volumes only.

Preferably, this liquidity service would be initiated by funding only the volumes of gas cycled into storage in the current year; but in the second year expand the service to include all working gas volumes. In subsequent years it may be possible to monetize some portion of the cushion gas for the participating utility (or utilities) 24.

As a point of reference the current volume for commercial paper in the credit markets far exceeds these kinds of volumes. The credit markets will be able to easily absorb this new volume of CP, especially as the risk structure will likely qualify these issues as AAA rated, or no lower than AA, rated issues, and the maturities will offer a broader range of selection than is currently available to credit market participants.

Commercial banks are required to attain a level of 8% of risk adjusted capital. Of that amount, at least 3% (so called Tier I capital) must be in the form of pure common equity. The banks' assets are categorized as to degree of risk, and the amount of capital to be held against each category is based on a scale of exposure agreed to under international guidelines. The assets of intermediary 22 will be ownership of a fungible commodity, natural gas, held in secure storage, with a guaranteed re-sale contract. The sales contract will be from entities whose bond credit rating is investment grade, BBB/Baa, or above. The default rate for these kinds of entities historically has been no more than 0.2%. If year 1 cycled volumes, and a likely price of $5.07/Mcf, the average daily balance of CP outstanding will approximate $4.9 billion. Three percent (3%) of this volume equates to nearly $150 million.

Looked at from the other perspective of risk based assets, the CP outstanding would fall into the 20% weighting category. Twenty percent (20%) of $4.9 billion outstanding equates to nearly $1.0 billion dollars of assets exposed, against which 8% equity should be held. Eight percent of $1.0 billion equates to $80 million in equity. It would represent sound strategy to use, from among a menu of risk management strategies, overcapitalization in the early years of operation as one of the pieces for positioning intermediary 22 for the “highest” credit rating attainable.

Assume intermediary 22 must earn at least a 15% return on investment after taxes, and that taxes average 38% of corporate earnings. Then Utilicredit would require a spread on its CP and invested capital averaging 0.63%, or 63 basis points over the cost of credit, assumed here at 6.5%, equivalent to a AA rating today.

Earnings of 15% after tax is equal to 15% divided by 1 minus the tax rate.

15%/(1−38%)=24.19%

Then based on equity at 3% of total assets,

24.19%×3%=0.007257

the pre-tax ROI must be equal to 0.007257 or about 73 basis points.

Assume further that operating expenses will average 10 basis points on the average daily balance (a/d/b) outstanding.

equal to $4.9 million

Then the total spread needed to cover the ROI and Opex would equal

(3% times the interest rate on the CP+the spread)+(97% times the spread)=83 basis points or 0.0083.

Assume the interest rate on the CP is 6.5%

3% times 6.5%+3% times S+97% times S=0.0083

100% S=0.0083−0.00195

spread required to earn a 15% after tax ROI and cover Opex=0.0063 or 0.63%

From analysis it may be determined, through a sample of the universe of likely participating utilities 24, that the bond rating of the participating utilities could apportion about as follows:

| | AAA | AA | A | BBB | Total |
|---|---|---|---|---|---|
| Grand Total | 0 | 4 | 20 | 19 | 43 |
| Percentage | 0.00% | 9.30% | 46.51% | 44.19% | 100.00% |
| Distribution | | | | | |

Assuming the pricing to the participating utilities should remain roughly equivalent to their current cost of liquidity in the early years, the target spread necessary to achieve the Return on Investment (ROI) objective for this relatively risk free non-bank financing can be earned.

Intermediary 22 will have operating expenses. The risk management advisory service 30 will have operating expenses. As was noted in the prior calculations, aggregate operating expenses of ten basis points is assumed. This amount of operating expense, expressed as a percentage of total assets, is well within the bounds of comparable non-bank credit delivery system type operations (e.g., the Farm Credit System).

Among the risks under management would be:

(1)interest rate risk;

(2)default risk;

(3)maturity risk;

(4)storage injection and deliverability risk;

(5)gas measurement risk (and audit);

(6)physical loss risk (during transmission and while in storage);

(7)business conditions risk;

(8)economic risk;

(9)price and weather hedge risks;

(10)credit market risks.

There will be no interest rate risk. The base interest rate to which a spread is added will be a variable rate, changed with each issue of CP, calculated by averaging the cost of the cumulative issues outstanding (assumed to be issued on a set day, weekly basis, e.g., on each Friday morning). What will be different will be the spread charged to each utility. Each utility will be separately underwritten, but the essence of the differential rate will be their bond rating, e.g., AA/Aa, A, BBB/Baa, etc., and the unique risk profile developed from the proprietary risk algorithm, see FIG. 6.

Credit rating agencies have performed historical studies on the default risk of investment grade securities. From this analysis will come the default risk calculation. In risk analysis models this has been referred to as the default-mode model. For example, using the binomial theorem, the probability of a default in any one year may be calculated, and the size of that default, hence the size of any price hedge that may be appropriate to offset this probability. These kinds of calculations will quantify the default value at risk in the portfolio at all times.

One of the principle sources of potential profit erosion will be in matching the timing of cash repayment of the utilities with the timing of the maturity schedule of the commercial paper, as to both volumes and price of the CP maturing, and the price of the pre-planned maturity. This erosion of profits would normally occur when early repayment from the utilities had to be reinvested in very short term fed funds (or equivalent), pending maturity of outstanding CP. This will happen constantly throughout the repayment cycle, but the objective is to minimize the time cash has to be held before retiring outstanding issues. A secondary market will also be used to minimize the effects of profit erosion. Deferred repayments from utilities can be handled by the rollover of maturing issues for short periods of time.

Commercial paper maturity schedules will be adopted early in the storage injection cycle. These maturity schedules will assume certain levels of storage deliverability, during the withdrawal season The technical status of the storage reservoir's ability to reach engineered performance capability will be continuously monitored to maximize Utilicredit's profitability. A “risk score” will be placed on each storage reservoir each year.

While the utility 24 will be responsible for payment for the quantities contracted, it will be necessary that the movement of the natural gas be tracked, and audited as to accuracy of volumes along the passage way to, into and from storage.

The risk manager will ensure proper insurance coverage's and loss payable clauses for the natural gas while in transit to storage and while in underground storage reservoirs.

A multi-state risk model takes into consideration more than just the historical probability of default. This is more of a dynamic model, taking into consideration the likelihood of a deterioration of the utility 24 in ability to pay. For example, the same rating agencies have determined that 5.3% of those firms having a credit rating of BBB declined to BB in one year. This dynamic analysis will be maintained by the risk management advisory service 30 so that the portfolio may be pro-actively managed and the profit margins protected. A principal early warning indicator will be the tracking, and grading, of an aging of accounts receivable by zip code within each utility 24 territory.

The territories served by each participating utility 24 will be modeled for natural gas demand sensitivity to changes in natural gas price levels as that price level change might impact household incomes, SIC categorized commercial and industrial profits. These households and firms will be surveyed quarterly.

While the intermediary 22 will own the natural gas, in the event of a default and non-payment, re-sale of the natural gas will be the responsibility of the intermediary. A price hedge, based on the probability of default, may be appropriate after the actual details of the portfolio of holdings are analyzed. Similarly, when the actual portfolio of participants, and the standard deviations of their typical withdrawal patterns are analyzed, a weather hedge may be purchased.

The risk manager will have the credit markets under daily scrutiny for changes in the markets appetite for risk, and liquidity, through a network of market reporting mechanisms from public and private sources, domestic and international, not the least of which will be the marketers of the CP.

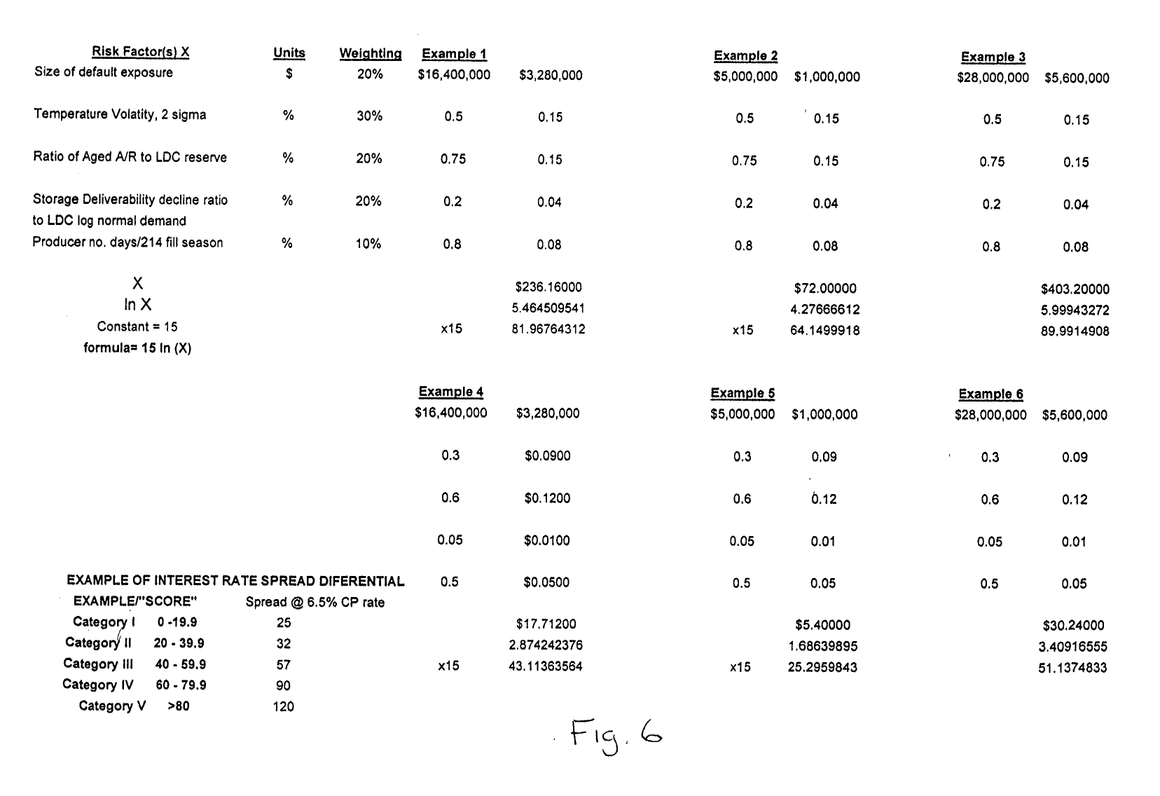

To provide a composite risk profile, the on and off balance sheet values at risk, and the stress test analysis have been combined into a composite algorithm, see FIG. 5. This algorithm is a way to assess the degree of risk in the portfolio by characterizing the dollar amounts outstanding, by category, and “score”.

FIVE (5) RISK FACTORS DETERMINE THE “SCORE”
OR CATEGORY:

| 1) On Balance Sheet Value at Risk | |
|---|---|
| weighting = 20% | |
| Probability of default as | e.g., 0.2%, 0.002 |
| determined by Moody's etc. | |
| Number of participants in the | e.g., 100 |
| portfolio | |
| Probability of loss from | e.g. 16.4% |
| default ratings | |
| Dollar size of | $5,000,000,000 |
| the portfolio | |
| Size of utility financing | $100,000,000 |
| On B/S V @ R = expected value | $16,400,000 |

This determines the default mode loss exposure of intermediary 22.

2) Off Balance Sheet Value at Risk

### Temperature Volatility

### weighting=30%

We compile a 100 year record for each day of the withdrawal season.

Calculate the standard deviation for each day.

Count the number of times in the 100 years that the temperature exceeded 2 standard deviations for that day.—e.g., 50 times

Express this as a percentage.—50%

Add up the percentages, e.g., 100 days at its %, e.g., 2500%

Divide by the number of times.—e.g., 2500 divided by 100 days=25%

This equates to the average excess over 2 standard deviations during the withdrawal season.

This is the expression for temperature volatility—a percentage

This determines the statistical maturity scheduling (uncertainty)

3) Business Conditions Model

weighting=20%

At the end of each month, or as frequently as necessary, collect reports on an aging of the accounts receivable.

The dollar amount <30 days has a 0 multiplier factor.

The dollar amount 30-60 days has a 20% factor.

The dollar amount 60-90 days has a 50% factor.

The dollar amount >90 days has a 100% weighting factor.

Sum the weightings in dollars.

Divide by the loss reserve on the utility books.

Percentage provides an indication of the stability or deterioration in the utility ability to repay its contract.

Trend change in percentage provides an indication of the stability or deterioration in the utility ability to repay its contract.

This determines the impact of price on ability to pay in the areas served.

4) Storage/Deliverability

weighting=20%

Collect data on each storage reservoir deliverability vs. bottom hole pressure (BHP).

Verify the deliverability from the reservoir year over year to determine any decline in ability to deliver at equal pressures.

Divide this decline expressed in MMcf/day by the log normal distribution of peak and low deliverability of the utility during withdrawal season.

Sum this for multiple reservoirs.

Calculate a weighted average for multiple reservoirs based on the volumes in storage in each.

This is the percentage which determines the ability to pay according to budget maturity schedules.

5) Producer Productive Capacity

weighting=10%

This gives the theoretical number of days to fulfill the contract

Divide this number of days by the remaining days in the fill season

This result is the percentage (of time needed to fill the contract)

Sum this for all producers under contract.

Calculate a weighted average for multiple producers based on the volume contracted from each.

This determines the accuracy of the maturity schedule based on historical statistical records.

The risk profile can be used to categorize the utility 24 and determine the interest rate spread that should be charged to the utility. The basic spread will be set depending upon the level of interest rates on the commercial paper issued by the intermediary 22, i.e., 5%, 5.5%, 6.0%, etc. Increments will be added to the basic spread to adjust for risk. Each of these factors weigh on the ability of the intermediary 22 to retire its commercial paper as it matures, and earn its targeted return.

The CP will be collateralized by:

(1)a security interest in the stored natural gas in the event of a default;

(2)by the overcapitalized equity position of the intermediary 22;

(3)by the binding sales agreement of the utility 24 on whose behalf the natural gas was purchased, and

(4)by the risk management methodology of the financing structure.

These risk management measures are expected to result in a AAA CP credit rating, but not less than a AA credit rating.

Computer programs will accommodate sophisticated management of the risk exposure of the intermediary 22. Each participating utility 24 will have its own secure web site within the data system of the intermediary 22. The first data to be submitted by each utility 24 will be a budget for the coming injection and withdrawal season as regards gas volumes and timing. Then as each contract is entered into, and sent over the Internet to the private web site, the data will be posted , analyzed and offset in the budget. As the prices paid under the contract are input, the economic model of the utility territory served will be analyzed to assess the likely impact of those prices on the customer's ability to pay, and the impact on projected consumption, and timing of that consumption, by Zip Code.

Each gas producer will be coded for summation of data across multiple utility contracts. Each individual producer contract and total reported contract commitment will be assessed for rate of production and delivery to storage on behalf of any specific utility 24 contract in light of a total commitment. Knowing the anticipated producing rate for storage fill is important for the marketing of the commercial paper. The marketing arm of intermediary 22 or an agency 28 must be able to communicate with the buyers of CP to keep them abreast of what kinds of dollar amounts, and maturities, will be available each week. Similarly, the intermediary 22 must set maturities at the time of CP issuance each week in accordance with the commitments of the participating utilities, and the statistical history of the timing of withdrawal from storage.

The off balance sheet values at risk for intermediary 22 will largely be related to the timing of repayment as to individual utility 24, and consolidated volumes and price. Early repayment prior to a specific maturity date will cause reinvestment of the cash at a rate lower than that being paid on the CP. A secondary market 36 in intermediary 22 CP will be helpful in managing this timing issue. Each storage reservoir will be coded for summation of data across multiple utility contracts. The individual utility 24, and total storage commitment, will be assessed for rate of deliverability from storage on behalf of any specific utility contract in light of the total commitment. The bottom hole pressure, and fill quantities, will be tracked throughout the year for measurement of changes in reservoir performance. Any deterioration in deliverability in relation to a given level of utility 24 area demand could potentially impact the planned repayment schedule of a specific utility 24. This is data that must be known as early as possible to alert the CP marketing agency 28, for example, for possible rollover quantities, for assessing the CP market appetite for rollovers, and resultant rollover maturities.

Each participating utility 24 will be required to furnish the risk manager with an aging of its accounts receivable, periodically. These numbers will be analyzed for their impact on the bond rating, its ability to sustain the rating, consistent with its legal and regulatory mandate to serve, and its internal risk management policies. Each year the risk manager will conduct a risk audit of each participating utility and will discuss its own risk assessment for improvement in subsequent years performance.

The initial baseline audit of a participating utility 24 will result in the construction of the one hundred year record of daily temperatures, the standard deviation of those temperatures, the frequency with which these deviations are exceeded, and the heating and cooling degree days. This data will set the parameters for the scheduling of injection and withdrawals from storage for each utility 24 and in total for all participating utilities. The utilitie' initial physical budget will reflect their experience with this same data. Intermediary 22 will be responsible for ownership of the natural gas until sold under the re-sale agreement. The injection and withdrawal timing issue becomes the responsibility of intermediary 22.

A method and system in accordance with the invention improves the efficiency of capital utilization for utilities which purchase and sell natural gas to its customers. Moreover, an entity (the financial intermediary 22) is created which facilitates the more efficient use of capital, not only by the utility “customer” of the financial intermediary, but the capital invested in the new entity financial intermediary provides a superior return on investment for its owners.

Although a preferred method and system for financing utility working gas storage inventories has been developed in accordance with the present invention those skilled in the art will further appreciate that various substitutions and modifications may be made without departing from the scope and spirit of the appended claims.

What is claimed is:

1. A method for acquiring and distributing natural gas in relatively large quantities by a gas utility company wherein the purchase of gas from a gas producer and to be distributed by said utility is financed by an intermediary entity, said method comprising the steps of:
negotiating at least one of the purchase, transport and storage cost of said gas by one of said utility and said intermediary entity;
providing payment by said intermediary entity for said gas and taking title to said gas by said intermediary entity;
carrying out one of transporting said gas to a storage facility and identifying said gas at a pre-determined storage facility;
acquiring funds to pay for gas purchased by said intermediary entity by issuing debt instruments by said intermediary entity through financial markets;
collecting payments by said intermediary entity from said utility for gas delivered to utility customers in accordance with a sales contract between said utility and said intermediary entity; and
repaying debt instruments at maturities thereof by said intermediary entity from funds received from said utility pursuant to said sales contract.

2. The method set forth in claim 1 including the steps of:
assessing the risk of receiving payment from said utility by said intermediary entity based on selected parameters related to geographical territories serviced by said utility for the purchase of gas from said utility by customers of said utility within said territories, respectively.

3. The method set forth in claim 2 wherein:
said risk assessment includes a determination of selected parameters within a geographic territory.

4. The method set forth in claim 3 wherein:
said parameters are determined for subdivisions of said geographic territory defined by postal service code.

5. The method set forth in claim 3 wherein:
said parameters are selected from a group consisting of population, residential housing units, retail merchant space, industrial production space, household income and sales tax receipts of said territories, respectively.

6. The method set forth in claim 3 wherein:
said parameters are selected from a group consisting of historical heating/cooling degree days, present weather forecast, and historical weather by one of an hourly and daily basis within said territories, respectively.

7. The method set forth in claim 2 including the steps of:
forecasting demand patterns for gas to be withdrawn from storage based on the parameters set forth in one of claims 5 and 6 and comparing said demand patterns with the capability of withdrawal of gas from said storage facility by a facility operator.

8. The method set forth in claim 7 including the step of:
notifying said facility operator of requirements to release gas from storage in accordance with a schedule derived from the steps of claim 7.

9. The method set forth in claim 2 including the step of:
forecasting expected cash flows from customers serviced by said utility in said territories.

10. The method set forth in claim 9 including the steps of:
determining the requirements for one of issuance and reissuance of debt instruments and at least one of monetary amounts thereof and maturity dates thereof and issuing debt instruments as required to finance the purchase of said gas by said intermediary entity and corresponding to expected cash flows to said intermediary entity from said utility.

11. The method set forth in claim 1 including the steps of:
determining an interest rate to be one of charged to said utility and paid on said debt instruments by assessing risks of loss by said intermediary entity, said risks of loss selected from a group consisting of interest rate risk, default on repayment of said debt instruments risk, maturity schedule of debt instruments risk, injection, storage and deliverability of said gas risk, gas measurement risk, physical loss of said gas during transmission and in storage risk, business conditions risk and economic risk.

12. The method set forth in claim 11 including the steps of:
determining an interest rate to be charged to said utility based on one or more of said risks.

13. The method set forth in claim 11 including the step of:
assigning a weight value to selected ones of said risks and determining a composite risk value.

14. The method set forth in claim 1 including the steps of:
determining the anticipated producing rate of gas for storage in said storage facility and determining the dollar volume of debt instruments available periodically based on said rate of production and delivery to storage.

15. The method set forth in claim 1 including the steps of:
monitoring pressures and fill quantities in said storage facility to determine storage facility performance and determining the extent of rollover of debt instruments as said debt instruments reach maturity based on said storage facility performance.

16. The method set forth in claim 1 including the step of:
monitoring the aging of accounts receivable of said utility to determine the risk associated with said intermediary entity achieving a predetermined return on investment.

17. The method set forth in claim 1 including the step of:
acquiring data with respect to said utility related to historical daily temperatures in a service territory served by said utility to determine the parameters of expected placement of gas in storage and withdrawal of gas from storage for said utility.
